(19) United States
(12) Patent Application Publication
(10) Pub. No.: US 2017/0161721 A1
(43) Pub. Date: Jun. 8, 2017

(54) METHOD AND SYSTEM FOR OPENING ACCOUNT BASED ON EUICC

(71) Applicant: CHINA UNITED NETWORK COMMUNICATIONS GROUP COMPANY LIMITED, Beijing (CN)

(72) Inventors: LING HAN, BEIJING (CN); YUNYONG ZHANG, BEIJING (CN); MINXIA GU, BEIJING (CN); BINFENG YAN, BEIJING (CN)

(21) Appl. No.: 15/368,525

(22) Filed: Dec. 2, 2016

(30) Foreign Application Priority Data
Dec. 3, 2015 (CN) 201510882564.7

(51) Int. Cl. G06Q 20/34; G06Q 20/40

(52) U.S. Cl. CPC G06Q 20/341; G06Q 20/4014

(57) ABSTRACT

Provided are a method and a system for opening an account based on an eUICC. The method includes: receiving, by an eUICC remote management platform, an account opening request forwarded by an operator management platform and comprising a user number, an eUICC identification and information of a service to be opened; allocating an ICCID; sending to the operator management platform an authentication parameter allocation request including the ICCID and the user number and receiving authentication parameters comprising an IMSI and an authentication key serial number fed back by the operator management platform; generating a complete profile according to the authentication parameters and a pre-stored initial profile; sending account opening parameters to the operator management platform to enable the operator management platform to perform a generation processing of an account opening order; downloading a complete profile to the eUICC and activating the complete profile.

### CROSS-REFERENCE TO RELATED APPLICATIONS

This application claims priority to Chinese Patent Application No. 201510882564.7, filed on Dec. 3, 2015, entitled “METHOD AND SYSTEM FOR OPENING ACCOUNT BASED ON EUICC , which is hereby incorporated by reference in its entirety.

### TECHNICAL FIELD

The present invention belongs to the technical field of smart cards, and in particular relates to a method and a system for opening an account based on an embedded universal integrated circuit card (eUICC).

### BACKGROUND

At present, eUICCs have derived an ability for supporting remote management. A plurality of operator's profiles may be stored in eUICCs. A user can select which number to use according to actual needs, and open the profile of the number for network connection.

An eUICC remote management platform is used to implement remote management of eUICCs, such as cooperating with an operator management platform to generate a profile corresponding to a number and downloading the profile to an eUICC, etc. Currently, a traditional smart card is often opened in a complete card mode or an incomplete card mode. When making a complete card, all profile data needs to be written into it, thus network resource parameters of the profile, such as mobile subscriber international ISDN/PSTN number (MSISDN) and international mobile subscriber identification number (IMSI), have already been occupied no matter whether the card is sold to a user or not. An existing incomplete card does not occupy MSISDN and IMSI resources, but users need to go to the business hall for selecting a number and the card is written on site. In addition, after an eUICC card is made, it usually needs to be integrated in a device, and the card cannot be written on later and cannot be easily replaced, so the incomplete card opening mode is not suitable for eUICCs. The presetting of resource parameters, such as numbers, is pre-occupation of number resources, such occupation will lead to an enormous loss of resources especially when users do not have account opening demands

### SUMMARY

Aiming at the problems in the prior art, embodiments of the present invention provides a method and a system for opening an account based on an eUICC. Through real-time allocation of number resources, the problems of exiting eUICCs, such as a waste of number resources caused by pre-occupation, and low utilization rate of number resources can be overcome.

An embodiment of the present invention provides a method for opening an account based on an eUICC, including:

receiving, by an eUICC remote management platform, an account opening request forwarded by an operator management platform, where the account opening request includes a user number, an eUICC identification and information of a service to be opened;

allocating, by the eUICC remote management platform, an integrated circuit card identifier (ICCID) corresponding to the account opening request from a stored ICCID range;

sending, by the eUICC remote management platform, to the operator management platform, an authentication parameter allocation request which includes the ICCID and the user number;

receiving, by the eUICC remote management platform, authentication parameters, which are sent by the operator management platform according to the authentication parameter allocation request and include an international mobile subscriber identification number (IMSI) and an authentication key serial number;

generating, by the eUICC remote management platform, a complete profile according to the authentication parameters and a pre-stored initial profile corresponding to the eUICC identification;

sending, by the eUICC remote management platform, to the operator management platform, account opening parameters, which are required for account opening and obtained according to the complete profile, to enable the operator management platform to perform a generation processing of an account opening order according to the account opening parameters;

after receiving an instruction of successful order generation sent by the operator management platform, downloading, by the eUICC remote management platform, the complete profile to the eUICC and activating the complete profile.

An embodiment of the present invention provides a system for opening an account based on an eUICC, including:

an eUICC remote management platform and an operator management platform, where the operator management platform includes an electronic sales system (ESS) sub-platform, a customer relationship management (CRM) sub-platform and a business support system (BSS) sub-platform;

the eUICC remote management platform including:

a first receiving module, configured to receive an account opening request forwarded by the ESS sub-platform, where the account opening request includes a user number, an eUICC identification and information of a service to be opened;

an allocating module, configured to allocate an ICCID corresponding to the account opening request from a stored ICCID range;

a first sending module, configured to send an authentication parameter allocation request to the CRM sub-platform, where the authentication parameter allocation request includes the ICCID and the user number;

a second receiving module, configured to receive authentication parameters, which are sent by the CRM sub-platform according to the authentication parameter allocation request and include an international mobile subscriber identification number (IMSI) and an authentication key serial number;

a profile generating module, configured to generate a complete profile, according to the authentication parameters and a pre-stored initial profile corresponding to the eUICC identification;

a second sending module, configured to send account opening parameters to the operator management platform, where the account opening parameters are required for account opening and obtained according to the complete profile, to enable the operator management platform to perform a generation processing of an account opening order according to the account opening parameters;

a profile processing module, configured to, after an instruction of successful order generation sent by the BSS sub-platform is received, download the complete profile to the eUICC and activate the complete profile.

The embodiments of present invention provide a method and a system for opening an account based on an eUICC. After receiving an account opening request including a user-selected user number, an eUICC identification and information of a service to be opened, the eUICC remote management platform first allocates a corresponding ICCID from a local stored ICCID range according to the user number, and then sends an allocation request to the operator management platform to request the operator management platform to allocate network parameters, such as IMSI, authentication key serial number, etc., and thereby generates a complete profile according to the user-selected user number, the information of the service and the network parameters allocated by the operator management platform in real time. And after the operator management platform completes an account opening order processing procedure on the network side based on the account opening parameters which are included in the profile and required for account opening on the network side, this profile is downloaded to the eUICC and activated to enable the user to connect with the network via the profile. When there is a need for opening a certain user number, the user selects the user number to trigger opening processing in real time, and the eUICC remote management platform and the operator management platform allocate corresponding ICCID, IMSI and key number resources in real time, thereby improving the utilization rate and avoiding a waste of number resources.

### BRIEF DESCRIPTION OF THE DRAWINGS

FIG. 1 is a flowchart of a first embodiment of a method for opening an account based on eUICC according to the present invention;

FIG. 2 is a flowchart of a second embodiment of a method for opening an account based on eUICC according to the present invention;

FIG. 3 is a schematic diagram of a first embodiment of a system for opening an account based on eUICC according to the present invention;

FIG. 4 is a schematic diagram of a second embodiment of a system for opening an account based on eUICC according to the present invention.

### DESCRIPTION OF EMBODIMENTS

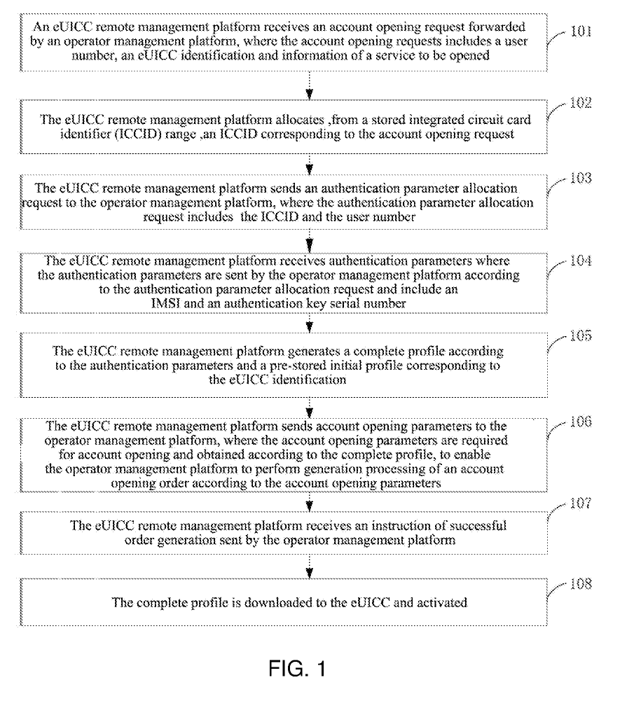

FIG. 1 is a flowchart of a first embodiment of a method for opening an account based on an eUICC according to the present invention. In this embodiment, the method for opening an account is executed by an eUICC remote management platform, and the entity interacting with the eUICC remote management platform is an operator management platform. However, it should be noted that, the operator management platform may include a plurality of sub-platforms, and each sub-platform may be an independent functional device, or be integrated in a same device (i.e., the operator management platform) as a functional module. In the embodiment, the operator management platform including an electronic sales system (ESS) sub-platform, customer relationship management (CRM) sub-platform, and business support system (BSS), is taken as an example for illustration, however, it is not limited to this example in actual application.

As shown in FIG. 1, the method for opening an account includes the following steps.

Step 101: An eUICC remote management platform receives an account opening request forwarded by an operator management platform, where the account opening requests includes a user number, an eUICC identification and information of a service to be opened.

In the embodiment, when a user wants to open an eUICC to use a user number for network communication, he can handle it in a corresponding operator's business hall, or by remotely accessing the operator management platform though an operator's client.

Taking the handling in the business hall as an example, the user can select the user number he wants to use and the information of a service he wants to open, such as plan information, on site. And then, the stuff can input the user-selected user number and the information of the service into the operator management platform which may be the ESS sub-platform.

It should be understood that, the user's personal information, such as ID number, may be input into the operator management platform to perform identity authentication for the user. For example, the user's personal information may be sent to the BSS sub-platform through the ESS sub-platform, so that the BSS sub-platform can perform identity authentication and customer data check for the user and after the authentication and check are passed, return a authentication-passed indication to the ESS sub-platform.

After the ESS sub-platform receives the authentication-passed indication, an interface may prompt to input an identification of an eUICC (EID) embedded in a terminal device of the user, thereby, generating an account opening request including the EID, the user number and the information of the service in the ESS sub-platform.

It should be understood that, when a user handles such business remotely via a client, the user can input the user number, the information of the service and the EID in a client interface according to a prompt, thereby generating the account opening request including these parameters and send it to the ESS sub-platform.

After receiving the account opening request, the ESS sub-platform forwards it to the eUICC remote management platform, so that the eUICC remote management platform obtains the parameters, such as the user number, the EID and the information of the service.

Step 102: The eUICC remote management platform allocates, from a stored integrated circuit card identifier (ICCID) range, an ICCID corresponding to the account opening request.

The ICCID range is pre-stored in the eUICC remote management platform, which allocates the ICCID for the account opening request in real time when receiving the account opening request. The allocation rules belong to prior art, which will not be described in detail in the embodiment.

Step 103: The eUICC remote management platform sends an authentication parameter allocation request to the operator management platform, where the authentication parameter allocation request includes the ICCID and the user number.

Step 104: The eUICC remote management platform receives authentication parameters, where the authentication parameters are sent by the operator management platform according to the authentication parameter allocation request and include an IMSI and an authentication key serial number.

the eUICC remote management platform then sends the authentication parameter allocation request carrying the ICCID and the user number to the operator management platform, here the authentication parameter allocation request may be specifically sent to the CRM sub-platform. Thereby, the CRM sub-platform allocates the corresponding authentication parameters according to the authentication parameter allocation request.

Here, the authentication parameters include the IMSI and the authentication key serial number, for instance, A4 key serial number and OP key serial number. In addition, the CRM sub-platform may allocate a short message service center (SMSC) according to the user number, and the SMSC is fed back to the eUICC remote management platform together with the authentication parameters. Specifically, the CRM sub-platform allocates the IMSI, SMSC and authentication key serial number according to the user number. The allocation rules belong to prior art, which will not be illustrated in detail herein.

In the embodiment, the network parameters may further include a transmission key sequence, which may specifically be a digital certificate encryption sequence. The transmission key sequence may be used to perform an encrypted transmission for some or all of the account opening parameters when they are sent to the operator management platform subsequently, so as to ensure the transmission security of these parameters.

Step 105: The eUICC remote management platform generates a complete profile according to the authentication parameters and a pre-stored initial profile corresponding to the eUICC identification.

The complete profile includes the ICCID, the user number, the IMSI, the authentication key serial number, as well as the authentication key, PIN, PUK, etc. included in the initial profile.

It should be understood that, the initial profile corresponding to the eUICC identification may be pre-stored in the eUICC remote management platform, and the initial profile may include some initialization data and the like of the eUICC. The above user number, ICCID, SMSC, IMSI and authentication key serial number, etc., may be written into the initial profile by the eUICC remote management platform, thereby forming the complete profile.

Step 106: The eUICC remote management platform sends account opening parameters to the operator management platform, where the account opening parameters are required for account opening and obtained according to the complete profile, to enable the operator management platform to perform generation processing of an account opening order according to the account opening parameters;

Step 107: The eUICC remote management platform receives an instruction of successful order generation sent by the operator management platform.

In order to complete the successful opening of the information of the service the user wants to open on the operator's network side, the eUICC remote management platform needs to send the account opening parameters required for the account opening to the operator management platform. Specifically, the account opening parameters required for the account opening on the network side and selected from the complete profile include the user number, ICCID, IMSI, authentication key, PIN, PUK and authentication key serial number.

In actual application, in order to ensure the transmission security of the account opening parameters, the eUICC remote management platform may first encrypt the authentication key by using the authentication key serial number, then encrypt the authentication key serial number, the encrypted authentication key, PIN, PUK by using the transmission key sequence, and send them to the BSS sub-platform via the ESS sub-platform together with the user number, ICCID and IMSI. Here, an operator may make his own determination on how to encrypt and decrypt, typically, a public key infrastructure may be used to generate a transmission key sequence for encryption and decryption.

It should be noted that, when receiving the account opening request, the ESS sub-platform may forward the account opening request to the BSS sub-platform, thereby enabling the BSS sub-platform to interact with the ESS sub-platform for billing and other processing. The interaction process belongs to prior art. However, although the interaction process has billing processing, it does not complete the whole account opening processing.

After receiving the above account opening parameters, the BSS sub-platform generates an account opening order, completes the account opening order, and then feeds back an instruction of successful order generation to the ESS sub-platform. Thereafter, the ESS sub-platform delivers the instruction to the eUICC remote management platform. Here, the BSS sub-platform interacts with the core network to complete the generation processing of the account opening order, which belongs to prior art and will not be illustrated in detail.

Step 108: The complete profile is downloaded to the eUICC and activated.

The eUICC remote management platform then downloads the complete profile and installs it on the eUICC, and then performs an activation processing to activate the profile so that the user can make use of the opened network service by enabling the profile.

In the embodiment, after receiving an account opening request carrying a user-selected user number, an eUICC identification and information of a service to be opened, the eUICC remote management platform first allocates a corresponding ICCID from a locally stored ICCID range according to the user number, then sends an allocation request for requesting allocation of authentication parameters such as IMSI, authentication key serial number, etc. to the operator management platform, thereby generating a complete profile according to the user-selected user number, the information of the service and the authentication parameters allocated by operator management platform in real time. After completing the opening order processing procedure on network side according to the account opening parameters of the profile, the operator management platform downloads the profile to the eUICC and activates the profile, so that the user can connect with the network by the profile. When there is a need for opening a certain user number, the user can select the user number to trigger the account opening processing, and the eUICC remote management platform and the operator management platform allocate relevant number resources such as ICCID and IMSI in real time, thereby increasing the utilization rate of number resources and avoiding a waste of number resources.

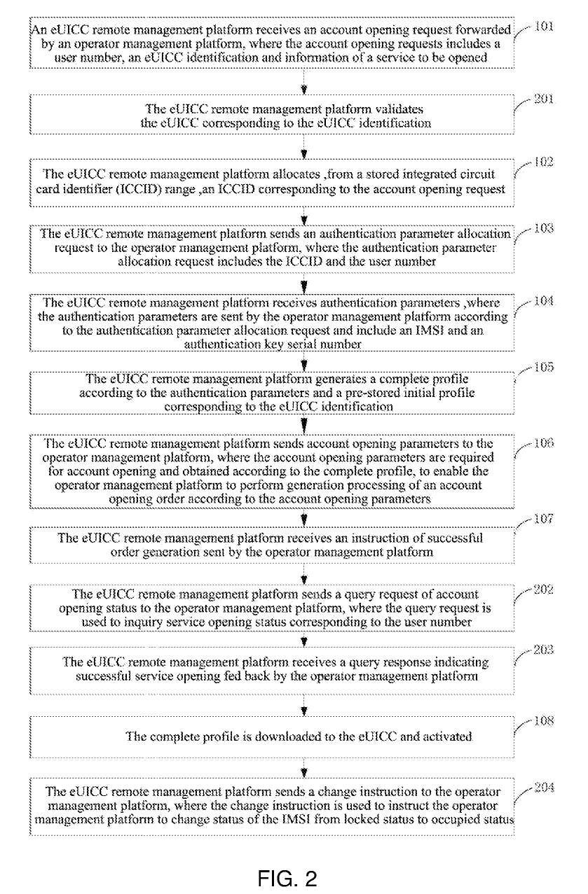

FIG. 2 is a flowchart of a second embodiment of a method for opening an account based on an eUICC according to the present invention. As shown in FIG. 2, the following steps are further included before Step 102.

Step 201: The eUICC remote management platform validates the eUICC corresponding to the eUICC identification.

In the embodiment, in order to ensure the user account opening to be reasonable, after receiving the account opening request, the eUICC remote management platform first needs to validate the eUICC to be opened.

Specifically, the validation of the eUICC corresponding to eUICC identification performed by the eUICC remote management platform, includes:

The eUICC remote management platform determines whether the eUICC identification exists;

When the eUICC identification exists, the eUICC remote management platform determines whether a binding relationship has been established between the eUICC identification and other user numbers;

When there is no binding relationship between the eUICC identification and other user numbers, the eUICC remote management platform establishes a binding relationship between the eUICC identification and the user number the user wants to open.

Moreover, the following steps are further included before Step 108.

Step 202: The eUICC remote management platform sends a query request of account opening status to the operator management platform, where the query request is used to inquiry service opening status corresponding to the user number.

Step 203: The eUICC remote management platform receives a query response indicating successful service opening fed back by the operator management platform.

In practical application, there may be a special case: the BSS sub-platform of the operator has successfully generated the account opening order and triggered the network side to implement the opening operation of the number, but the number is still not successfully opened for some reasons.

Therefore, in this embodiment, after receiving the above instruction of successful order generation, the eUICC remote management platform may inquire the BSS sub-platform about the account opening status through the ESS sub-platform after a certain delay, so as to make sure of successful opening. If a quire response indicating successful service opening, which is fed back by the BSS sub-platform, is received, proceed to Step 108, otherwise, end subsequent processing.

After Step 108, further include:

Step 204: The eUICC remote management platform sends a change instruction to the operator management platform, where the change instruction is used to instruct the operator management platform to change status of the IMSI from locked status to occupied status.

Here, when the operator management platform generates the IMSI, the status of IMSI is set as the locked status.

In the embodiment, after the operator management platform, i.e., the CRM sub-platform, allocates the network parameters, such as IMSI, etc., the status of IMSI may be set as locked status, that means the IMSI is temporarily occupied. After successfully activating the above profile, the eUICC remote management platform sends a change instruction to the CRM sub-platform, so as to instruct the CRM sub-platform to change the status of IMSI from locked status to occupied status, which means that the IMSI is formally occupied.

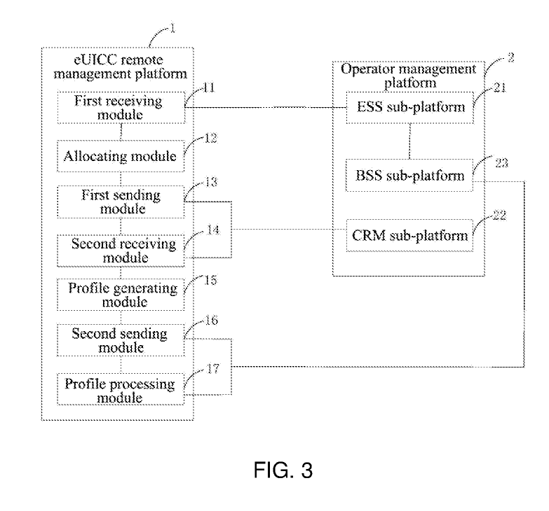

FIG. 3 is a schematic diagram of a first embodiment of a system for opening an account based on an eUICC according to the present invention. As shown in FIG. 3, the system includes an eUICC remote management platform 1 and an operator management platform 2.

The operator management platform 2 includes an ESS sub-platform 21, a CRM sub-platform 22 and a BSS sub-platform 23.

The eUICC remote management platform 1 includes a first receiving module 11, an allocating module 12, a first sending module 13, a second receiving module 14, a profile generating module 15, a second sending module 16 and a profile processing module 17.

The first receiving module 11 is configured to receive an account opening request forwarded by the ESS sub-platform 21, where the account opening request includes a user number, an eUICC identification and information of a service to be opened.

The allocating module 12 is configured to allocate an ICCID corresponding to the account opening request from a stored ICCID range.

The first sending module 13 is configured to send an authentication parameter allocation request to the CRM sub-platform 22, where the authentication parameter allocation request includes the ICCID and the user number.

The second receiving module 14 is configured to receive authentication parameters which are sent by the CRM sub-platform 22 according to the authentication parameter allocation request, where the authentication parameters include an IMSI and an authentication key serial number.

The profile generating module 15 is configured to generate a complete profile according to the authentication parameters and a pre-stored initial profile corresponding to the eUICC identification.

The second sending module 16 is configured to send account opening parameters, which are required for account opening and obtained according to the complete profile, to the BSS sub-platform 23, to enable the BSS sub-platform 23 to perform a generation processing of an account opening order according to the account opening parameters.

The profile processing module 17 is configured to, after an instruction of successful order generation sent by the BSS sub-platform 23 is received, download the complete profile to the eUICC and activate the complete profile.

The account opening system of the present embodiment may be used to implement the technical solution of the method embodiment as shown in FIG. 1, they have similar implementation principles and technical effects, which will not be repeated here.

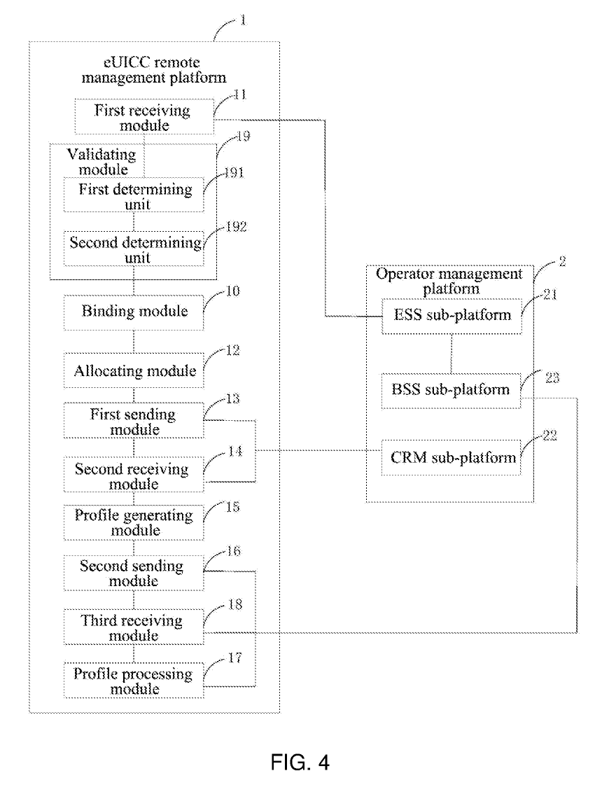

FIG. 4 is a schematic diagram of a second embodiment of a system for opening an account based on an eUICC according to the present invention. As shown in FIG. 4, on the basis of the embodiment as shown in FIG. 3, the second sending module 16 is further used to:

Send a query request of account opening status to the BSS sub-platform 23, where the query request is used to inquiry service opening status corresponding to the user number.

The eUICC remote management platform 1 further includes a third receiving module 18.

The third receiving module 18 is configured to receive a query response fed back by the BSS sub-platform 23.

The profile processing module 17 is specifically configured to, when the third receiving module 18 receives a query response indicating successful service opening, perform the step of downloading the complete profile into the eUICC and activating the complete profile.

Furthermore, the first sending module 11 is further configured to send a change instruction to the CRM sub-platform 22, where the change instruction is used to instruct the CRM sub-platform 22 to change status of IMSI from locked status to occupied status; where, when the CRM sub-platform 22 generates the IMSI, the IMSI is set as the locked status.

Furthermore, the eUICC remote management platform 1 further includes a validating module 19.

The validating module 19 is configured to validate the eUICC corresponding to the eUICC identification.

Specifically, the validating module 19 includes:

A first determining unit 191, configured to determine whether the eUICC identification exists;

A second determining unit 192, configured to determine whether a binding relationship has been established between the eUICC identification and other user numbers, when the first determining unit 191 determines that the eUICC identification exists.

The eUICC remote management platform further includes a binding module 10.

The binding module 10 is configured to establish a binding relationship between the eUICC identification and the user number, when the second determining unit 192 determines that there is no binding relationship between the eUICC identification and other user numbers.

The account opening system of the embodiment may be used to implement the technical solution of the method embodiment as shown in FIG. 2, they have similar implementation principles and technical effects which will not be repeated here.

A person of ordinary skill in the art should understand that, some or all of the steps of the method embodiment may be implemented by a program instructing relevant hardware. The program may be stored in a computer readable storage medium, and when the program is executed, the steps of the above method embodiments are executed. The storage medium includes various medium that can be stored, such as ROM, RAM, disketteor and disk, etc.

Finally, it should be noted that the above embodiments are only used to illustrate the technical solutions of the present invention, rather than to limit. Although the present invention has been described in detail with reference to the aforementioned embodiments, the person skilled in the art should understand that it is still possible to modify the technical solutions described by the foregoing embodiments, or equivalently replace part of or all of the technical features; however, these modifications or replacements will not make the nature of corresponding technical solutions depart from the scope of technical solutions in the embodiments of the present invention.

What is claimed is:

1. A method for opening an account based on an embedded universal integrated circuit card (eUICC), comprising:
receiving, by an eUICC remote management platform, an account opening request which are forwarded by an operator management platform and comprises a user number, an eUICC identification and information of a service to be opened;
allocating, by the eUICC remote management platform, an integrated circuit card identifier (ICCID) corresponding to the account opening request from a stored ICCID range range;
sending, by the eUICC remote management platform, to the operator management platform, an authentication parameter allocation request including the ICCID and the user number;
receiving, by the eUICC remote management platform, authentication parameters, which are sent by the operator management platform according to the authentication parameter allocation request and comprise an international mobile subscriber identification number (IMSI) and an authentication key serial number;
generating, by the eUICC remote management platform, a complete profile according to the authentication parameters and a pre-stored initial profile corresponding to the eUICC identification;
sending, by the eUICC remote management platform, to the operator management platform, account opening parameters, which are required for account opening and obtained according to the complete profile, to enable the operator management platform to perform a generation processing of an account opening order according to the account opening parameters;
after receiving an instruction of successful order generation sent by the operator management platform, downloading, by the eUICC remote management platform, a complete profile to the eUICC and activating the complete profile.

2. The method according to claim 1, wherein after receiving the instruction of successful order generation sent by the operator management platform, the method further comprises:
sending, by the eUICC remote management platform, a query request of account opening status to the operator management platform, wherein the query request is used to inquiry service opening status corresponding to the user number;
when receiving, by the eUICC remote management platform, a query response indicating successful service opening fed back by the operator management platform, performing, by the eUICC remote management platform, the step of downloading the complete profile to the eUICC and activating the complete profile.

3. The method according to claim 1, wherein after downloading the complete profile to the eUICC and activating the complete profile, the method further comprises:
sending, by the eUICC remote management platform, to the operator management platform, a change instruction, wherein the change instruction is used to instruct the operator management platform to change status of the IMSI from locked status to occupied status, wherein the status of the IMSI is set as the locked status when the operator management platform generates the IMSI.

4. The method according to claim 1, wherein after receiving the account opening request forwarded by the operator management platform, the method further comprises:
validating, by the eUICC remote management platform, the eUICC corresponding to the eUICC identification.

5. The method according to claim 4, wherein the validating, by the eUICC remote management platform, the eUICC corresponding to the eUICC identification, comprises:
determining, by the eUICC remote management platform, whether the eUICC identification exists;
when the eUICC identification exists, determining, by the eUICC remote management platform, whether a binding relationship has been established between the eUICC identification and other user numbers;
when there is no binding relationship between the eUICC identification and other user numbers, establishing, by the eUICC remote management platform, the binding relationship between the eUICC identification and the user number.

6. A system for opening an account based on an eUICC, comprising:
an eUICC remote management platform and an operator management platform, the operator management platform comprising an electronic sales system (ESS) sub-platform, a customer relationship management (CRM) sub-platform and a business support system(BSS) sub-platform;
wherein the eUICC remote management platform comprises:
a first receiving module, configured to receive an account opening request forwarded by the ESS sub-platform, wherein the account opening request comprises a user number, an eUICC identification and information of a service to be opened;
an allocating module, configured to allocate an integrated circuit card identifier (ICCID) corresponding to the account opening request from a stored ICCID range range;
a first sending module, configured to send an authentication parameter allocation request to the CRM sub-platform, wherein the authentication parameter allocation request comprises the ICCID and the user number;
a second receiving module, configured to receive authentication parameters, which are sent by the CRM sub-platform according to the authentication parameter allocation request and comprise an international mobile subscriber identification number (IMSI) and an authentication key serial number;
a profile generating module, configured to generate a complete profile according to the authentication parameters and a pre-stored initial profile corresponding to the eUICC identification;
a second sending module, configured to send account opening parameters to the operator management platform, wherein the account opening parameters are required for the account opening and obtained according to the complete profile, to enable the operator management platform to perform a generation processing of an account opening order according to the account opening parameters;
a profile processing module, configured to, after an instruction of successful order generation sent by the BSS sub-platform is received, download the complete profile to the eUICC and activate the complete profile.

7. The system according to claim 6, wherein the second sending module is further configured to:
send a query request of account opening status to the BSS sub-platform, wherein the query request of the account opening status is used to inquiry service opening status corresponding to the user number;
wherein the eUICC remote management platform further comprises:
a third receiving module, configured to receive a query response fed back by the BSS sub-platform;
wherein the profile processing module is configured to, when the third receiving module receives a query response indicating successful service opening, perform the step of downloading the complete profile to the eUICC and activating the complete profile.

8. The system according to claim 6, wherein the first sending module is further configured to:
send a change instruction to the CRM sub-platform, wherein the CRM sub-platform is used to instruct the CRM sub-platform to change status of the IMSI from locked status to occupied status, wherein the status of the IMSI is set as the locked status when the CRM sub-platform generates the IMSI.

9. The system according to claim 6, wherein the eUICC remote management platform further comprises:
a validating module, configured to validate the eUICC corresponding to the eUICC identification.

10. The system according to claim 9, wherein the validating module comprises:
a first determining unit, configured to determine whether the eUICC identification exists;
a second determining unit, configured to determine whether a binding relationship has been established between the eUICC identification and other user numbers, when the first determining unit determines that the eUICC identification exists;
the eUICC remote management platform further comprising:
a binding module, configured to establish a binding relationship between the eUICC identification and the user number, when the second determining unit determines that there is no binding relationship between the eUICC identification and other user numbers.
